(19) United States
(12) Patent Application Publication
(10) Pub. No.: US 2023/0419837 A1
(43) Pub. Date: Dec. 28, 2023

(54) NOTIFICATION DEVICE FOR PEDESTRIAN, NOTIFICATION SYSTEM FOR PEDESTRIAN, NOTIFICATION METHOD FOR PEDESTRIAN, AND NON-TRANSITORY STORAGE MEDIUM STORING A PROGRAM

(71) Applicant: TOYOTA JIDOSHA KABUSHIKI KAISHA, Toyota-shi Aichi-Ken (JP)

(72) Inventors: Takahiro KATO, Numazu-shi Shizuoka-ken (JP); Takashi KASHIMURA, Nagoya-shi Aichi-ken (JP); Masatoshi SATOH, Toyota-shi Aichi-ken (JP)

(73) Assignee: TOYOTA JIDOSHA KABUSHIKI KAISHA, Toyota-shi Aichi-ken (JP)

(21) Appl. No.: 18/211,628

(22) Filed: Jun. 20, 2023

(30) Foreign Application Priority Data
Jun. 24, 2022 (JP) 2022-102120

(51) Int. Cl. G08G 1/16; G08G 1/01

(52) U.S. Cl. CPC G08G 1/166; G08G 1/0129

(57) ABSTRACT

A notification device for a pedestrian includes: a current position information acquisition section configured to acquire current position information; a danger spot information acquisition section configured to acquire information relating to danger spots at which dangerous driving has occurred in the past; and a notification section configured to provide notification in a case in which a distance between a current position and a danger spot becomes less than or equal to a predetermined threshold value.

### CROSS-REFERENCE TO RELATED APPLICATION

This application is based on and claims priority under 35 USC 119 from Japanese Patent Application No. 2022-102120 filed on Jun. 24, 2022, the disclosure of which is incorporated by reference herein.

### BACKGROUND

### Technical Field

The present disclosure relates to a notification device for a pedestrian, a notification system for a pedestrian, a notification method for a pedestrian, and a non-transitory storage medium that stores a program.

### Related Art

International Publication No. 2019/240070 discloses an information communication system including a first portable terminal carried by a youngster such as a child or the like, a second portable terminal carried by a guardian, and a data center. It is further disclosed that, on the basis of position information of the first portable terminal and danger information expressing dangerous places, the control section of the data center generates a voice message and outputs the voice message from a speaker of the first portable terminal, and generates notification information and outputs the notification information to a vibrator of the first portable terminal.

In International Publication No. 2019/240070, places where a disaster has occurred, places where there are many traffic accidents, places where suspicious persons have appeared, and the like are set as dangerous places. Here, places where there are many traffic accidents include places where accidents between vehicles occur often. Spots that are particularly dangerous for pedestrians, such as spots where dangerous driving and traffic violations occur often, are not set as dangerous places. Therefore, there is room for improvement in order to improve the safety of pedestrians.

### SUMMARY

The present disclosure provides a notification device for a pedestrian, a notification system for a pedestrian, a notification method for a pedestrian, and a non-transitory storage medium that stores a program, which can improve the safety of a pedestrian.

A notification device for a pedestrian of a first aspect includes: a current position information acquisition section acquiring current position information; a current position information acquisition section configured to acquire current position information; a danger spot information acquisition section configured to acquire information relating to danger spots at which dangerous driving has occurred in the past; and a notification section configured to provide notification in a case in which a distance between a current position and a danger spot becomes less than or equal to a predetermined threshold value.

In the notification device for a pedestrian of the first aspect, current position information of the notification device for a pedestrian is acquired by the current position information acquisition section. Further, the danger spot information acquisition section acquires information relating to danger spots at which dangerous driving has occurred in the past. Moreover, the notification section notifies the pedestrian who is the user, in a case in which the distance between the current position and a danger spot becomes less than or equal to a predetermined threshold value. Due thereto, the user can know that he/she is approaching a danger spot.

Further, because spots where dangerous driving has occurred in the past are set as danger spots, the user can be notified at spots where dangerous driving and traffic violations have occurred frequently.

In a notification device for a pedestrian of a second aspect, in the first aspect, the danger spot information acquisition section acquires information relating to danger spots at which dangerous driving due to inattention by drivers of vehicles has occurred in the past, and does not acquire information relating to danger spots at which dangerous driving due to inattention by pedestrians has occurred.

In the notification device for a pedestrian of the second aspect, the danger spot information acquisition section does not acquire information relating to danger spots at which dangerous driving due to inattention of pedestrians has occurred. Therefore, as compared with a structure in which notification is given at spots where all types of dangerous driving have occurred, annoyance can be reduced while ensuring the safety of the user.

In a notification device for a pedestrian of a third aspect, in the first aspect, the danger spot information acquisition section acquires information including spots where a number of times that vehicles have carried out sudden braking in the past is a predetermined number or more, as the danger spots.

In the notification device for a pedestrian of the third aspect, notification is not given in a case in which the number of times that vehicles have carried out sudden braking in the past is less than a predetermined number of times. Due thereto, annoyance can be reduced while ensuring the safety of the user.

In a notification device for a pedestrian of a fourth aspect, in the third aspect, the danger spot information acquisition section acquires information including spots where a number of times that vehicles have carried out sudden braking immediately after a left or right turn in the past is a predetermined number or more, as the danger spots.

In the notification device for a pedestrian of the fourth aspect, spots where vehicles have suddenly braked at times of traveling straight are excluded from the danger spots. A case in which a vehicle carries out sudden braking while traveling straight is often a case in which the intervehicle distance between the own vehicle and the preceding vehicle has become close or the like. Therefore, by excluding such events that are not dangerous to pedestrians, the annoyance can be reduced while the safety of the user is ensured.

In a notification device for a pedestrian of a fifth aspect, in the third aspect, in a case in which a number of times that vehicles have carried out sudden braking in the past on plural roads connected to an intersection is a predetermined number or more, the danger spot information acquisition section acquires the intersection as a danger spot.

In the notification device for a pedestrian of the fifth aspect, in a case in which the number of times that vehicles have carried out sudden braking in the past on plural roads connected to an intersection is a predetermined number or more, the danger spot information acquisition section acquires the intersection as a danger spot. Due thereto, the number of danger spots can be reduced as compared with a case in which the respective roads are made to be danger spots. Further, management as a dangerous intersection is possible.

In a notification device for a pedestrian of a sixth aspect, in the first aspect, the danger spot information acquisition section acquires information including spots where a number of times that temporary stoppage violations of vehicles have occurred in the past is a predetermined number or more, as the danger spots.

In the notification device for a pedestrian of the sixth aspect, notification is not given in a case in which the number of times that temporary stoppage violations of vehicles have occurred in the past is less than a predetermined number of times. Due thereto, the annoyance can be reduced while the safety of the user is ensured.

In a notification device for a pedestrian of a seventh aspect, in the first aspect, the danger spot information acquisition section acquires information including spots where a number of times that speeding of vehicles has occurred in the past is a predetermined number or more, as the danger spots.

In the notification device for a pedestrian of the seventh aspect, notification is not given in a case in which the number of times that speeding of vehicles has occurred in the past is less than a predetermined number of times. Due thereto, the annoyance can be reduced while the safety of the user is ensured.

In a notification device for a pedestrian of an eighth aspect, in the first aspect, the danger spot information acquisition section acquires information including spots where a number of times that sudden steering of vehicles has occurred in the past is a predetermined number or more, as the danger spots.

In the notification device for a pedestrian of the eighth aspect, notification is not given in a case in which the number of times that sudden steering of vehicles has occurred in the past is less than a predetermined number of times. Due thereto, the annoyance can be reduced while the safety of the user is ensured.

A notification system for a pedestrian of a ninth aspect is a notification system for a pedestrian that includes: the notification device for a pedestrian of any one of the first aspect through the eighth aspect; and a server in which information relating to the danger spots is stored, wherein the server acquires travel information regarding times of travel from vehicles, and the notification system updates information relating to danger spots on the basis of the acquired travel information.

In the notification system for a pedestrian of the ninth aspect, travel information is acquired from vehicles, and information relating to danger spots is updated on the basis of the acquired travel information. Due thereto, as compared with a case in which the information relating to danger spots is updated by acquiring information of traffic accidents and the like from an external server or the like, spots where dangerous driving occurs can be effectively registered as danger spots regardless of the absence/presence of traffic accidents thereat.

A notification method for a pedestrian of a tenth aspect includes: acquiring current position information; acquiring information relating to danger spots at which dangerous driving has occurred in the past; and providing notification in a case in which a distance between a current position and a danger spot becomes less than or equal to a predetermined threshold value.

A non-transitory storage medium storing a program of an eleventh aspect causes a computer to perform processing of: acquiring current position information; acquiring information relating to danger spots at which dangerous driving has occurred in the past; and providing notification in a case in which a distance between a current position and a danger spot has become less than or equal to a predetermined threshold value.

As described above, the notification device for a pedestrian, the notification system for a pedestrian, the notification method for a pedestrian, and the program relating to the present disclosure can improve the safety of a pedestrian.

### BRIEF DESCRIPTION OF THE DRAWINGS

An exemplary embodiment of the present disclosure will be described in detail based on the following figures, wherein:

FIG. 1 is a schematic drawing illustrating the overall structure of a notification system for a pedestrian relating to an embodiment;

FIG. 2 is a block drawing illustrating hardware structures of a notification device for a pedestrian relating to the embodiment;

FIG. 3 is a block drawing illustrating hardware structures of a server in the embodiment;

FIG. 4 is a block drawing illustrating hardware structures of a vehicle in the embodiment;

FIG. 5 is a block drawing illustrating functional structures of the server in the embodiment;

FIG. 6 is a block drawing illustrating functional structures of the notification device for a pedestrian relating to the embodiment;

FIG. 7 is a schematic drawing illustrating the distance between the notification device for a pedestrian and a danger spot;

FIG. 8 is a schematic drawing illustrating examples of danger spots;

FIG. 9 is a schematic drawing illustrating another example of a danger spot;

FIG. 10 is a schematic drawing illustrating yet another example of a danger spot;

FIG. 11 is a flowchart illustrating an example of the flow of danger spot updating processing in the embodiment; and

FIG. 12 is a flowchart illustrating an example of the flow of notification processing in the embodiment.

### DETAILED DESCRIPTION

A notification system S for a pedestrian that includes a notification device 10 for a pedestrian relating to an embodiment is described. The notification system S for a pedestrian is a system that, in a case in which a user who is carrying the notification device 10 for a pedestrian approaches a danger spot, causes the user to recognize that he/she is at a danger spot by notifying the user.

(Overall Structure)

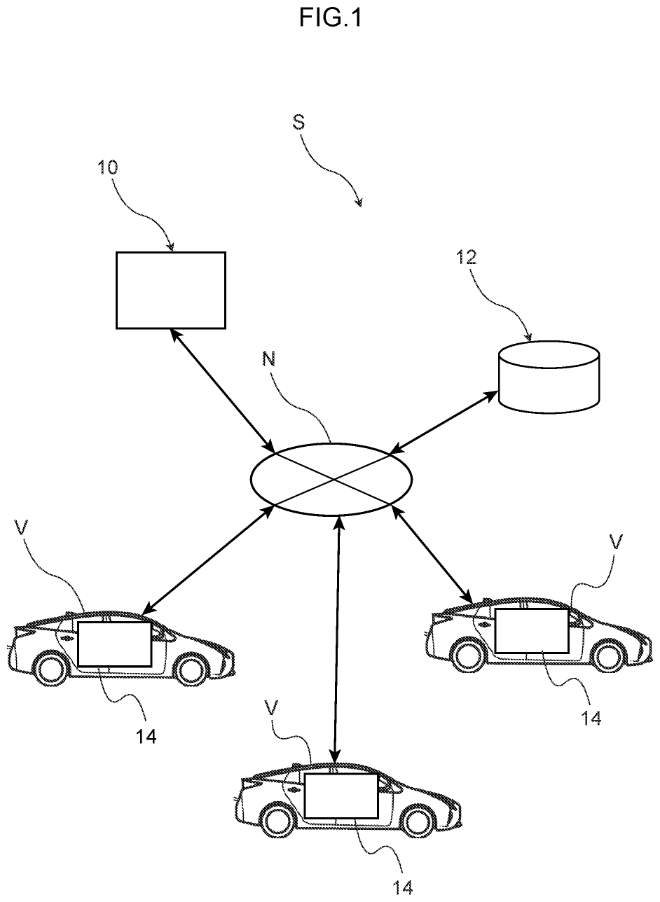

As illustrated in FIG. 1, the notification system S for a pedestrian of the present embodiment is structured to include the notification device 10 for a pedestrian and a server 12. The notification device 10 for a pedestrian and the server 12 are structured so as to be able to communicate with one another via network N. Onboard devices 14 that are installed in vehicles V are connected to the network N. The notification device 10 for a pedestrian, the server 12 and the onboard device 14 are structured so as to be able to communicate with one another via the network N. Note that, although a state in which three of the vehicles V are connected to the notification device 10 for a pedestrian and the server 12 is illustrated in FIG. 1, the number of the vehicles V is not limited.

The notification device 10 for a pedestrian relating to the present embodiment is formed in a shape that can be attached to the pedestrian, for example, is attached to the belt portion of a shoulder bag carried by a child such as a youngster or the like. Information relating to danger spots is stored in the server 12. The server 12 is set at a company that manages the notification device 10 for a pedestrian, or a data center, or the like.

(Hardware Structures of Notification Device 10 for a Pedestrian)

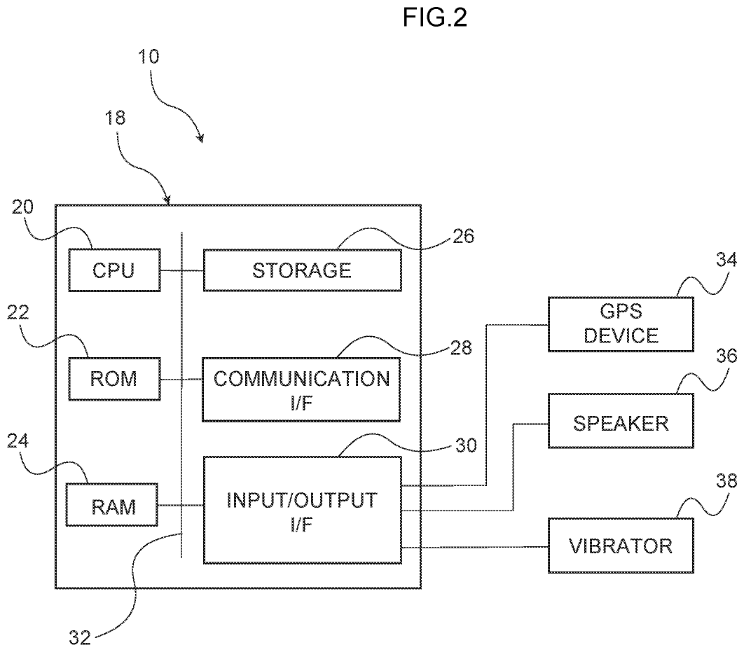

FIG. 2 is a block drawing illustrating hardware structures of the notification device 10 for a pedestrian. As illustrated in FIG. 2, the notification device 10 for a pedestrian has a control section 18. The control section 18 is structured to include a CPU (Central Processing Unit: processor) 20, a ROM (Read Only Memory) 22, a RAM (Random Access Memory) 24, a storage 26, a communication I/F (communication interface) 28, and an input/output I/F (input/output interface) 30. These respective structures are connected so as to be able to communicate with one another via bus 32.

The CPU 20 is a central computing processing unit, and executes various programs and controls respective sections. Namely, the CPU 20 reads-out a program from the ROM 22 or the storage 26, and executes the program by using the RAM 24 as a workspace. The CPU 20 carries out control of the above-described respective structures, and various computing processings, in accordance with programs recorded in the ROM 22 or the storage 26.

The ROM 22 stores various programs and various data. The RAM 24 temporarily stores programs and data as a workspace. The storage 26 is structured by an HDD (Hard Disk Drive) or an SSD (Solid State Drive), and stores various programs, including the operating system, and various data. In the present embodiment, a program for carrying out notification processing, various data and the like are stored in the ROM 22 or the storage 26.

The communication I/F 28 is an interface for the control section 18 to communicate with the server 12 and external devices and the like. Standards such as, for example, CAN (Controller Area Network), Ethernet®, LTE (Long Term Evolution), FDDI (Fiber Distributed Data Interface), Wi-Fi® or the like are used at the communication I/F 28.

A GPS (Global Positioning System) device 34, a speaker 36, and a vibrator 38 are electrically connected to the input/output interface I/F 30. The GPS device 34 is a device that measures the current position of the notification device 10 for a pedestrian by receiving GPS signals from GPS satellites.

The speaker 36 outputs sound such as a voice message or the like in a case in which a predetermined condition is satisfied. The vibrator 38 operates, and vibrates the notification device 10 for a pedestrian, in a case in which a predetermined condition is satisfied.

(Hardware Structures of Server 12)

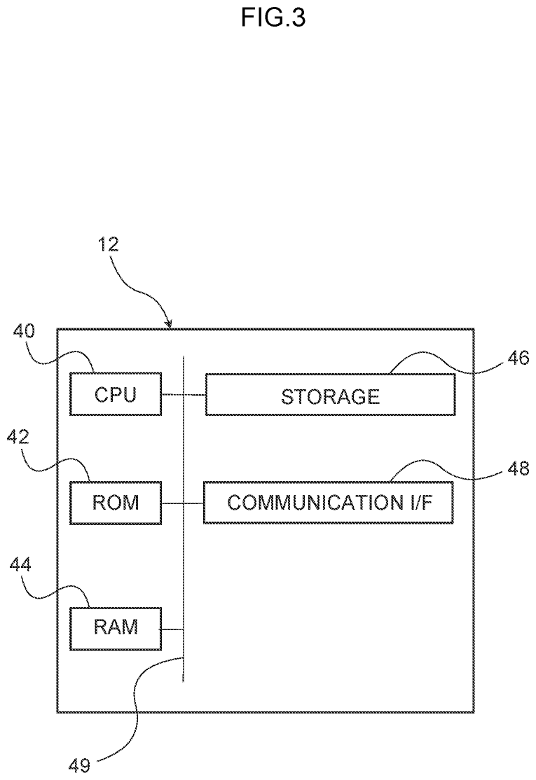

FIG. 3 is a block drawing illustrating hardware structures of the server 12. As illustrated in FIG. 3, the server 12 is structured to include a CPU (Central Processing Unit: processor) 40, a ROM (Read Only Memory) 42, a RAM (Random Access Memory) 44, a storage 46 and a communication I/F (communication interface) 48. These respective structures are connected so as to be able to communicate with one another via bus 49.

The CPU 40 is a central computing processing unit, and executes various programs and controls respective sections. Namely, the CPU 40 reads-out a program from the ROM 42 or the storage 46, and executes the program by using the RAM 44 as a workspace. The CPU 40 carries out control of the above-described respective structures, and various computing processings, in accordance with programs recorded in the ROM 42 or the storage 46.

The ROM 42 stores various programs and various data. The RAM 44 temporarily stores programs and data as a workspace. The storage 46 is structured by an HDD (Hard Disk Drive) or an SSD (Solid State Drive), and stores various programs, including the operating system, and various data. In the present embodiment, a program for carrying out danger spot setting processing, map information and danger spot information are stored in the ROM 42 or the storage 46.

The communication I/F 48 is an interface for the server 12 to communicate with unillustrated external devices. Standards such as, for example, CAN (Controller Area Network), Ethernet®, LTE (Long Term Evolution), FDDI (Fiber Distributed Data Interface), Wi-Fi® or the like are used at the communication I/F 48.

(Hardware Structures of Vehicle V)

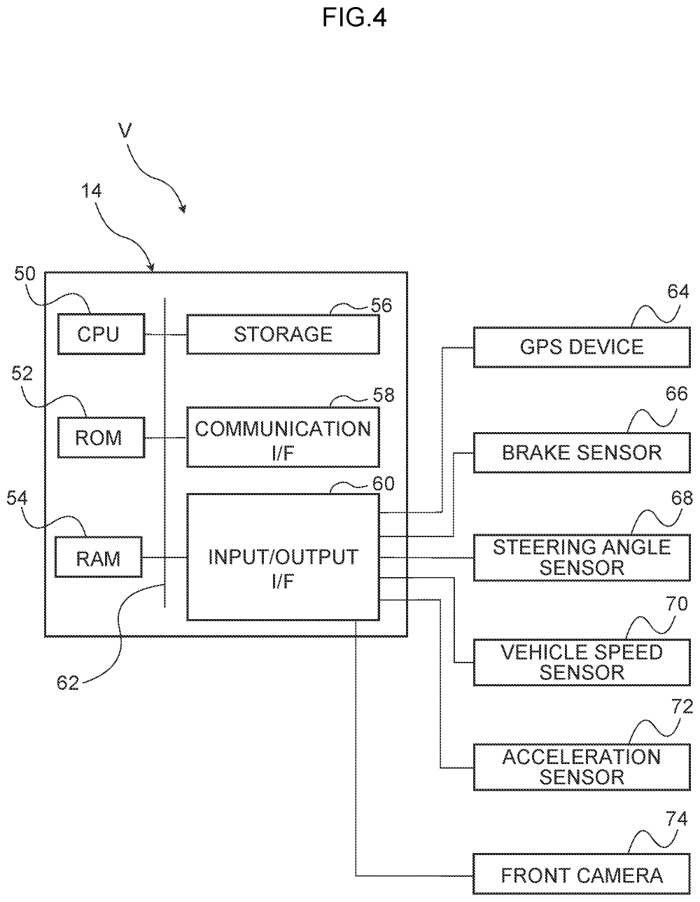

FIG. 4 is a block drawing illustrating hardware structures of the vehicle V. As illustrated in FIG. 4, the vehicle V has the onboard device 14. The onboard device 14 is structured to include a CPU (Central Processing Unit: processor) 50, a ROM (Read Only Memory) 52, a RAM (Random Access Memory) 54, a storage 56, a communication I/F (communication interface) 58, and an input/output I/F (input/output interface) 60. These respective structures are connected so as to be able to communicate with one another via bus 62.

The CPU 50 is a central computing processing unit, and executes various programs and controls respective sections. Namely, the CPU 50 reads-out a program from the ROM 52 or the storage 56, and executes the program by using the RAM 54 as a workspace. The CPU 50 carries out control of the above-described respective structures, and various computing processings, in accordance with programs recorded in the ROM 52 or the storage 56.

The ROM 52 stores various programs and various data. The RAM 54 temporarily stores programs and data as a workspace. The storage 56 is structured by an HDD (Hard Disk Drive) or an SSD (Solid State Drive), and stores various programs, including the operating system, and various data. In the present embodiment, a program for carrying out notification processing, various data and the like are stored in the ROM 52 or the storage 56.

The communication I/F 58 is an interface for the vehicle V to communicate with the server 12 and external devices and the like. Standards such as, for example, CAN (Controller Area Network), Ethernet®, LTE (Long Term Evolution), FDDI (Fiber Distributed Data Interface), Wi-Fi® or the like are used at the communication I/F 58.

A GPS (Global Positioning System) device 64, a brake sensor 66, a steering angle sensor 68, a vehicle speed sensor 70 and an acceleration sensor 72 are electrically connected to the input/output interface I/F 60. The GPS device 64 is a device that measures the current position of the vehicle V by receiving GPS signals from GPS satellites.

The brake sensor 66 is structured so as to be able to detect the amount of depression of an unillustrated brake pedal provided at the vehicle V. Information relating to the depressed amount of the brake pedal that is detected by the brake sensor 66 is transmitted to the onboard device 14.

The steering angle sensor 68 is structured so as to be able to detect the steering angle of an unillustrated steering wheel provided at the vehicle V. Information relating to the steering angle that is detected by the steering angle sensor 68 is transmitted to the onboard device 14.

The vehicle speed sensor 70 detects the speed of the vehicle V and transmits the detected speed to the onboard device 14. The acceleration sensor 72 detects the acceleration of the vehicle V and transmits the detected acceleration to the onboard device 14. Note that the acceleration sensor 72 does not have to be provided in a case in which the acceleration is calculated from the speed information of the vehicle V.

A front camera 74 is provided at the front portion of the vehicle V, and captures images of the region in front of the vehicle V. Image information captured by the front camera 74 is transmitted to the onboard device 14.

(Functional Structures of Notification Device 10 for a Pedestrian)

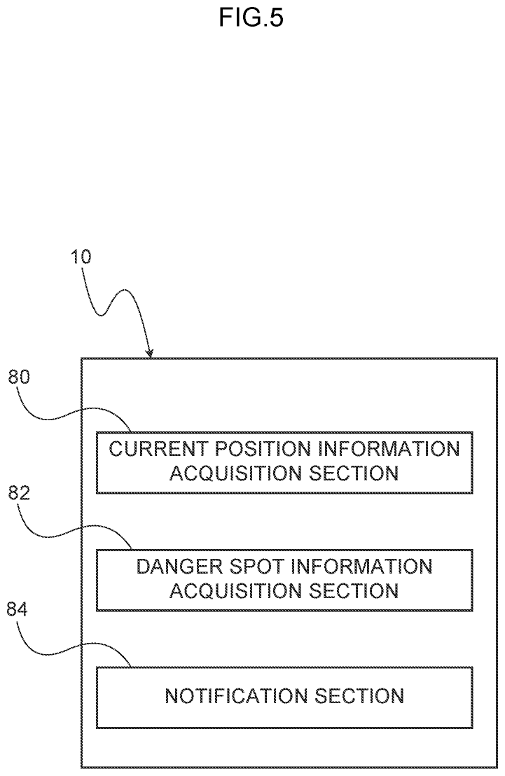

The notification device 10 for a pedestrian realizes various functions by using the above-described hardware resources. The functional structures realized by the notification device for a pedestrian are described with reference to FIG. 5.

As illustrated in FIG. 5, the notification device 10 for a pedestrian is structured to include, as the functional structures thereof, a current position information acquisition section a danger spot information acquisition section 82, and a notification section 84. Note that these respective functional structures are realized by the CPU 20 reading-out and executing a program stored in the ROM 22 or the storage 26.

The current position information acquisition section 80 acquires current position information of the notification device 10 for a pedestrian. Specifically, the current position information acquisition section 80 acquires position information measured by the GPS device 34.

The danger spot information acquisition section 82 acquires information relating to danger spots where dangerous driving has occurred in the past. Specifically, via the network N, the danger spot information acquisition section 82 acquires danger spot information that is stored in the ROM 42 or the storage 46 of the server 12.

Note that the danger spot information acquisition section 82 may acquire danger spot information from the server 12 at a predetermined period, and store the danger spot information in the storage 26 of the notification device 10 for a pedestrian. Further, the danger spot information acquisition section 82 may acquire only danger spot information of the periphery of the current position on the basis of the current position information of the notification device 10 for a pedestrian.

As an example, the danger spot information acquisition section 82 of the present embodiment is structured so as to acquire, from the server 12, only danger spot information of a range of a 5 km periphery of the current position of the notification device 10 for a pedestrian. Further, the danger spot information is stored in the storage 26 of the notification device 10 for a pedestrian, and, immediately after the notification device 10 for a pedestrian starts-up or immediately after the notification device 10 for a pedestrian stops, the danger spot information acquisition section 82 acquires only the updated portion of the danger spot information from the server 12, and updates the danger spot information that is stored in the storage 26.

Here, the danger spot information acquisition section 82 of the present embodiment acquires information that includes, as danger spots, spots where the number of times when the vehicles V have braked suddenly in the past is a predetermined number or more, spots where the number of times when the vehicles V have violated a temporary stoppage regulation in the past is a predetermined number or more, spots where the number of times that speeding of the vehicles V has occurred in the past is a predetermined number or more, and spots where the number of times that sudden steering of the vehicles V has occurred in the past is a predetermined number or more.

Further, in the present embodiment, the danger spot information acquisition section 82 is structured so as to acquire information relating to danger spots where there has arisen dangerous driving that is due to inattention of the drivers of the vehicles V, and to not acquire information relating to spots where there has arisen dangerous driving that is due to the inattention of pedestrians. Dangerous driving that is due to inattention of the driver of the vehicle V is violating a temporary stoppage regulation due to lack of confirmation by the driver, speeding, sudden braking, sudden steering, and the like. Further, dangerous driving that is due to inattention of a pedestrian is cases in which the vehicle V suddenly brakes or suddenly steers due to a pedestrian ignoring a signal, cases in which the vehicle V suddenly brakes or suddenly steers due to a pedestrian rushing-out into the road without looking left and right, and the like. For example, data relating to danger spots where dangerous driving that is due to inattention of drivers has occurred, and data relating to danger spots where dangerous driving that is due to inattention of pedestrians has occurred, may be stored separately in the server 12 in advance, and the danger spot information acquisition section 82 may acquire only the data relating to dangerous driving that is due to driver inattention.

Note that any of various methods can be employed as the method for judging whether or not an event is dangerous driving that is due to inattention of a pedestrian. For example, in a case in which a pedestrian is carrying the notification device 10 for a pedestrian, the time series data of the position information may be referred to on the basis of the current position information acquired by the current position information acquisition section 80, and it may be judged that an event is dangerous driving that is due to the inattention of a pedestrian, in a case in which the dangerous driving occurs as a result of the speed of the pedestrian changing suddenly to the extent of being unavoidable by the driver. Further, it may be judged that an event is dangerous driving that is due to the inattention of a pedestrian, in a case in which the dangerous driving occurs at the time when a pedestrian crosses a road at a place other than a pedestrian crossing. Moreover, it may be judged that an event is dangerous driving that is due to the inattention of a pedestrian, in a case in which the dangerous driving occurs at the time when the pedestrian crosses the road with the pedestrian signal being in a state indicating that advancing is prohibited, i.e., in a case in which the dangerous driving occurs as a result of the pedestrian having ignored the signal.

Further, it may be judged that an event is dangerous driving that is due to inattention of a pedestrian, in a case in which inattention of a pedestrian is detected from image information captured by the front camera 74 of the vehicle V, even if the notification device for a pedestrian is not attached to the pedestrian.

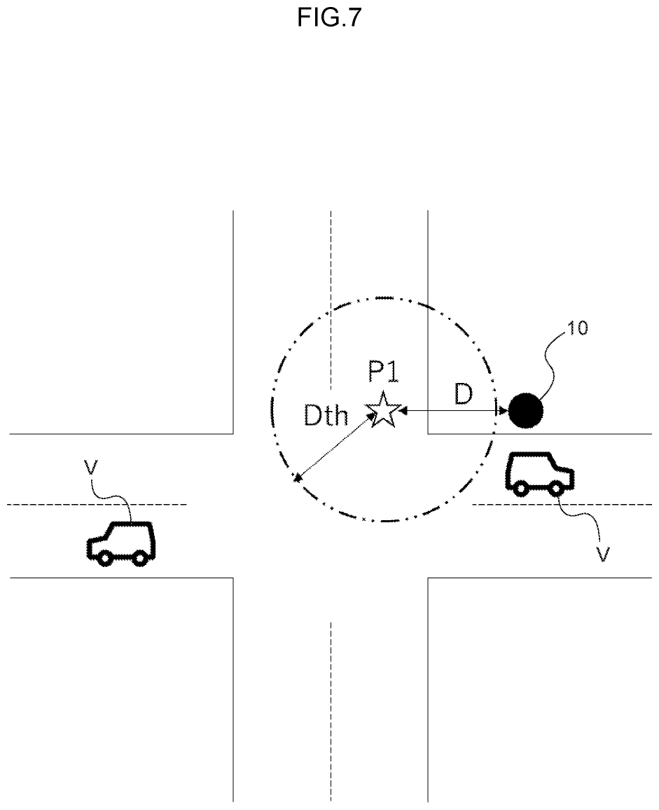

The notification section 84 notifies the pedestrian that is the user, in a case in which the distance between the current position and a danger spot becomes less than or equal to a predetermined threshold value. The function of this notification section 84 is described with reference to FIG. 7.

FIG. 7 is a schematic drawing of the periphery of an intersection at which a danger spot is set. As illustrated in FIG. 7, danger spot P1 is set near the intersection. The information of the danger spot P1 is stored in the server 12. Because the danger spot P1 is a danger spot where dangerous driving due to inattention of drivers has occurred, information of the danger spot P1 is stored in the storage 26 of the notification device 10 for a pedestrian by the danger spot information acquisition section 82.

The black dot near the danger spot P1 shows the position of the notification device for a pedestrian. Namely, the position of the pedestrian to which the notification device for a pedestrian is attached is expressed by the black dot. Here, the notification section 84 of the present embodiment notifies the user in a case in which the distance between the current position of the pedestrian (the notification device 10 for a pedestrian) and the danger spot P1 becomes less than or equal to threshold value Dth. In the state illustrated in FIG. 7, notification is not given because distance D between the pedestrian and the danger spot P1 is greater than the threshold value Dth.

In a case in which the distance D between the pedestrian and the danger spot P1 becomes less than or equal to the threshold value Dth due to the pedestrian approaching the danger spot P1 further than the state of FIG. 7, the notification section 84 notifies the pedestrian. Specifically, the notification section 84 notifies the pedestrian by at least one of the speaker 36 and the vibrator 38.

In a case in which the notification section 84 notifies the pedestrian by the speaker 36, the notification section 84 notifies the pedestrian by outputting sound, such as a voice message or the like, from the speaker 36. At this time, the volume of the speaker 36 may be varied in accordance with the distance between the pedestrian and the danger spot P1. Further, the notification section 84 may change the voice message outputted from the speaker 36, in accordance with the distance between the pedestrian and the danger spot P1.

In a case in which the notification section 84 notifies the pedestrian by the vibrator 38, the notification section 84 notifies the pedestrian by operating the vibrator 38 and causing the notification device 10 for a pedestrian to vibrate. At this time, the notification section 84 may vary the output (amplitude) of the vibrator 38 in accordance with the distance between the pedestrian and the danger spot P1. Further, the notification section 84 may change the vibrating pattern of the vibrator 38 in accordance with the distance between the pedestrian and the danger spot P1.

(Functional Structures of Server)

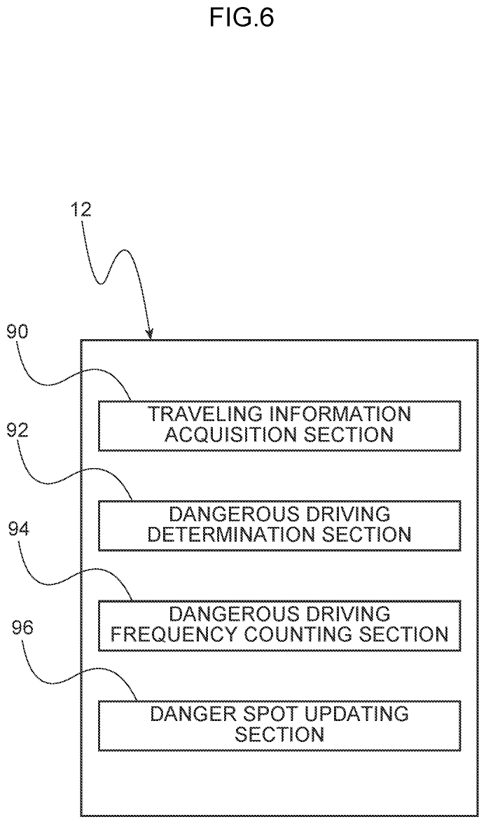

The server 12 realizes various functions by using the above-described hardware resources. The functional structures that are realized by the server 12 are described with reference to FIG. 6.

As illustrated in FIG. 6, the server 12 is structured to include, as the functional structures thereof, a travel information acquisition section 90, a dangerous driving judging section 92, a dangerous driving frequency counting section 94, and a danger spot updating section 96. These respective functional structures are realized by the CPU 40 reading-out and executing a program stored in the ROM 42 or the storage 46.

The travel information acquisition section 90 acquires travel information of times of traveling from the vehicles V. Specifically, the travel information acquisition section 90 issues requests for travel information to the vehicles V that can communicate with the server 12 via the network N, and acquires travel information of times of traveling from the vehicles V. What is called travel information here is time series data of the brake operation amount, time series data of the acceleration, time series data of the vehicle speed, time series data of the steering angle, time series data of position information, and the like.

The time series data of the brake operation amount is, for example, data in which the amount of depression of the brake pedal acquired by the brake sensor 66 is stored in time series. The time series data of the acceleration is, for example, data in which the acceleration of the vehicle V acquired by the acceleration sensor 72 is stored in time series. The time series data of the vehicle speed is, for example, data in which the speed of the vehicle V acquired by the vehicle speed sensor 70 is stored in time series. The time series data of the steering angle is, for example, data in which the steering angle of the vehicle V acquired by the steering angle sensor 68 is stored in time series. The time series data of the position information is, for example, data in which position information of the vehicle V acquired by the GPS device 64 is stored in time series.

In addition to the above-described data, the travel information acquisition section 90 may acquire time series data of the depressed amount of the accelerator pedal, or the like. Further, the travel information acquisition section 90 may acquire time series data of image information captured by the front camera 74, and in particular, may acquire information relating to signs ahead of the vehicle V that are detected on the basis of the image information. Moreover, the travel information acquisition section 90 may acquire information relating to drive assist functions that operate while the vehicle V is traveling. For example, in a case in which a drive assist function such as the ABS (Antilock Brake System) or PCS (Pre-Crash Safety system) or the like operates during traveling of the vehicle V, the travel information acquisition section 90 may acquire the type of the drive assist function that operated, and time information and position information of the operation.

Note that the timing of the transmitting of travel information from the vehicle V to the server 12 is not particularly limited. For example, travel information may be transmitted to the server 12 at the time when the vehicle V stops. Or, for example, travel information may be transmitted in real time while the vehicle V is traveling.

The dangerous driving judging section 92 judges whether or not the information acquired by the travel information acquisition section 90 from the vehicle V is dangerous driving. An example of the judgment as to whether or not the information is dangerous driving is described hereinafter.

From time series data of the brake operation amount of the vehicle V, the dangerous driving judging section 92 judges whether or not sudden braking has been carried out as dangerous driving. Specifically, the dangerous driving judging section 92 judges that sudden braking has been carried out in a case in which, from the time series data of the brake operation amount, the brake operation amount becomes greater than or equal to a predetermined threshold value in a short time. Further, the dangerous driving judging section 92 may judge whether or not sudden braking has occurred on the basis of time series data of the acceleration, in addition to or instead of the time series data of the brake operation amount.

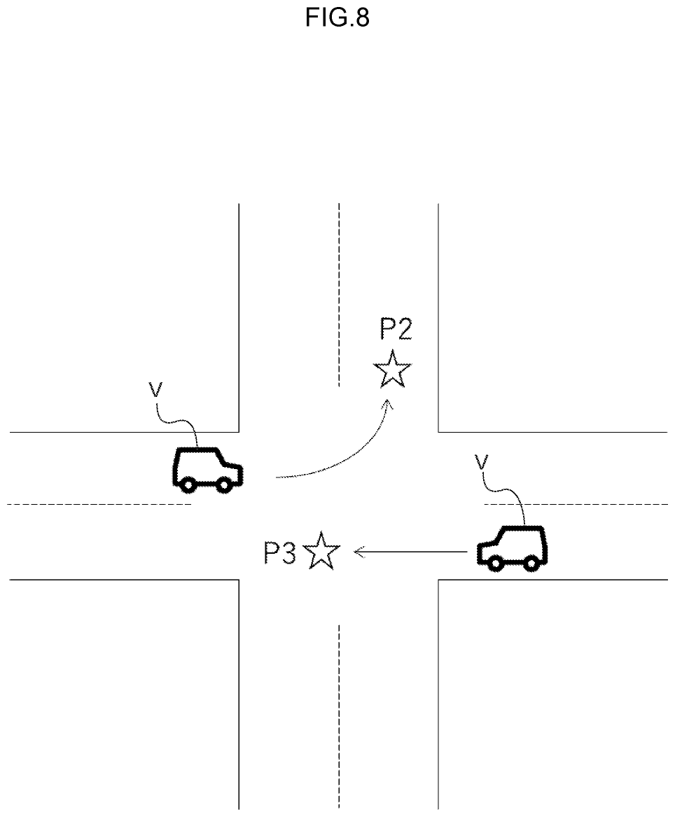

Here, in the present embodiment, as an example, the dangerous driving judging section 92 judges that sudden braking has occurred as dangerous driving in a case in which the vehicle V carried out sudden braking immediately after turning left or right. Further, the dangerous driving judging section 92 judges that sudden braking has not been carried out, in a case in which sudden braking occurs while the vehicle V is traveling straight. Namely, sudden braking during straight traveling of the vehicle V is judged to not correspond to sudden braking that is dangerous driving. These events are described with reference to FIG. 8.

FIG. 8 is a schematic drawing of a periphery of an intersection. In this FIG. 8, spot P2 that is set near the intersection is a spot where sudden braking was carried out immediately after the vehicle V made a left turn. Therefore, the dangerous driving judging section 92 judges that sudden braking which is dangerous driving has occurred at the spot P2.

On the other hand, in FIG. 8, spot P3 that is set near the intersection is a spot where sudden braking was carried out in a state in which the vehicle V was traveling straight. In this way, a case in which the inter-vehicle distance between the own vehicle and an unillustrated preceding vehicle traveling in front of the own vehicle becomes short, and a case in which an object such as a fallen object or the like appears on the road, and the like are examples of cases in which sudden braking is carried out while the vehicle V is traveling straight. Namely, when sudden braking is carried out in a state in which the vehicle V is travelling straight, there are often cases in which there is little effect on pedestrians. In such a case, the dangerous driving judging section 92 judges that sudden braking is not carried out at spot P3.

From the time series data of the steering angle of the vehicle V, the dangerous driving judging section 92 judges whether or not sudden steering (sudden operation of the steering wheel) that is dangerous driving has been carried out. Specifically, from the time series data of the steering angle, the dangerous driving judging section 92 judges that sudden steering has been carried out in a case in which the steering angle becomes a predetermined threshold value or greater in a short time.

Further, from the time series data of the speed of the vehicle V, the dangerous driving judging section 92 judges whether speeding that is dangerous driving has been carried out. Specifically, from the time series data of the steering angle, the dangerous driving judging section 92 judges that speeding has been carried out in a case in which the vehicle speed is greater than or equal to a predetermined threshold value. Note that the dangerous driving judging section 92 may acquire the speed limit of the road on which the vehicle V is traveling on the basis of position information of the vehicle V, and may judge that there is speeding in a case in which the vehicle V travels at a speed that is predetermined amount or more greater than this speed limit.

In a case in which information of the speed limit of the road is included in the map information stored in the storage 46 of the server 12, the dangerous driving judging section 92 can judge whether or not there has been speeding, on the basis of this speed limit information and the time series data of the vehicle speed. Further, even in a case in which information of the speed limit of the road is not included in the map information stored in the storage 46, if the travel information acquisition section 90 can acquire time series data of image information captured by the front camera 74, the dangerous driving judging section 92 can judge whether or not speeding has occurred, on the basis of the time series data of the vehicle speed and information of signs relating to the speed limit that are detected on the basis of the image information.

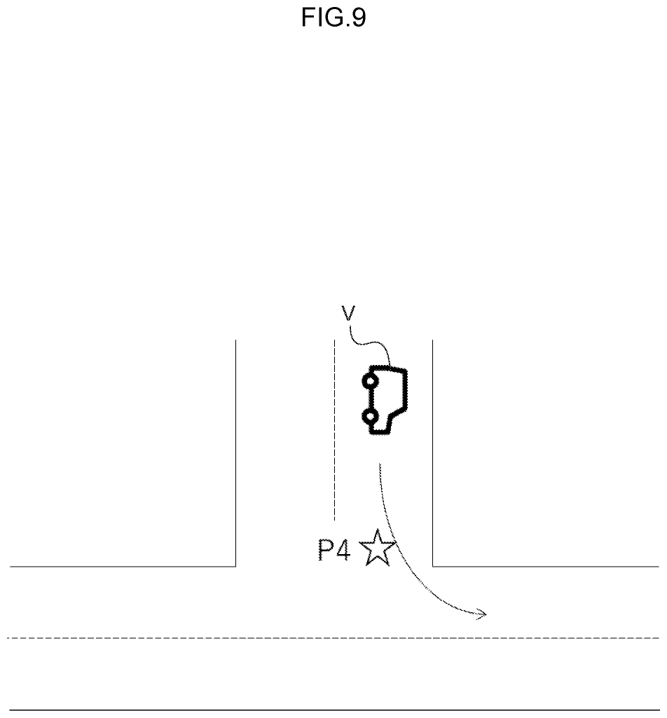

The dangerous driving judging section 92 judges whether or not violation of a temporary stoppage regulation that is dangerous driving has occurred, from time series data of the speed of the vehicle V and time series data of the position information. Specifically, in a case in which the speed of the vehicle V is not 0 at a spot of temporary stoppage, the dangerous driving judging section 92 judges that a temporary stoppage violation has occurred. For example, in a case in which places of temporary stoppage are recorded in map information stored in the server 12, if the vehicle speed is not 0 even though the position information of the vehicle V is at a place of temporary stoppage, the dangerous driving judging section 92 judges that a temporary stoppage violation has occurred. Further, in a case in which places of temporary stoppage are not recorded in the map information stored in the server 12, the dangerous driving judging section 92 judges by another method whether or not a temporary stoppage violation has occurred. An example of such a method is described with reference to FIG. 9.

FIG. 9 is a schematic drawing of the vicinity of a three-way junction. In FIG. 9, the vehicle V, which is traveling on a road that merges into a road of straight traveling that is the priority road, generally stops temporarily at the time of merging into the straight traveling road. Therefore, as illustrated in FIG. 9, in a case in which the vehicle V merges into the straight traveling road without stopping temporarily, the dangerous driving judging section 92 may judge that a temporary stoppage violation has occurred. In this case, it is judged that the temporary stoppage violation has occurred at spot P4 that is at the near side of the straight traveling road.

Further, even at crossroads or in cases in which the road widths greatly differ, the road of a wide width is the priority road, and the road of the narrow width is the non-priority road. Therefore, if the vehicle speed at the time of merging from a non-priority road into a priority road is not 0, the dangerous driving judging section 92 may judge that a temporary stoppage violation has occurred.

In FIG. 6, the dangerous driving frequency counting section 94 counts, for each spot, the number of times that the dangerous driving judging section 92 has judged that there has been dangerous driving thereat. Specifically, the number of times that it was judged that there was dangerous driving is stored for each spot in the server 12. For a spot at which there is judged to be dangerous driving by the dangerous driving judging section 92, the dangerous driving frequency counting section 94 adds one to the number of times that is stored in the server 12, so as to update the number of times. Here, for a spot at which there is judged to be dangerous driving, the dangerous driving frequency counting section 94 specifies the spot on the basis of position information acquired from the GPS device 64 of the vehicle V. Further, if, near a spot at which there is judged to be dangerous driving, there exists a spot at which there was judged to be dangerous driving in the past, the dangerous driving frequency counting section 94 may consider that dangerous driving has been carried out at the same spot. Here, a spot that is near means, for example, a spot that is in a range of around from 5 m to 30 m.

The danger spot updating section 96 updates the information relating to danger spots by registering a spot, at which the number of times of dangerous driving counted by the dangerous driving frequency counting section 94 is a predetermined number or more, in the server 12 as a danger spot. Specifically, the danger spot updating section 96 registers, as danger spots and in the server 12, spots at which the number of times that sudden braking was carried out immediately after the vehicle V turned left or right is a predetermined number or more, spots at which the number of times that a temporary stoppage violation of the vehicle V occurred is a predetermined number or more, spots at which the number of times that speeding of the vehicle V occurred is a predetermined number or more, and spots at which the number of times that sudden steering of the vehicle V was carried out is a predetermined number or more.

Further, the danger spot updating section 96 may register a spot at which the total number of times of dangerous driving is a predetermined number or more, as a danger spot in the server 12. Or, the danger spot updating section 96 may register a spot at which the number of times of dangerous driving within a predetermined time period is a predetermined number or more, as a danger spot in the server 12. For example, a spot where the number of times of dangerous driving within the past 5 years has exceeded 10 times may be registered in the server 12 as a danger spot.

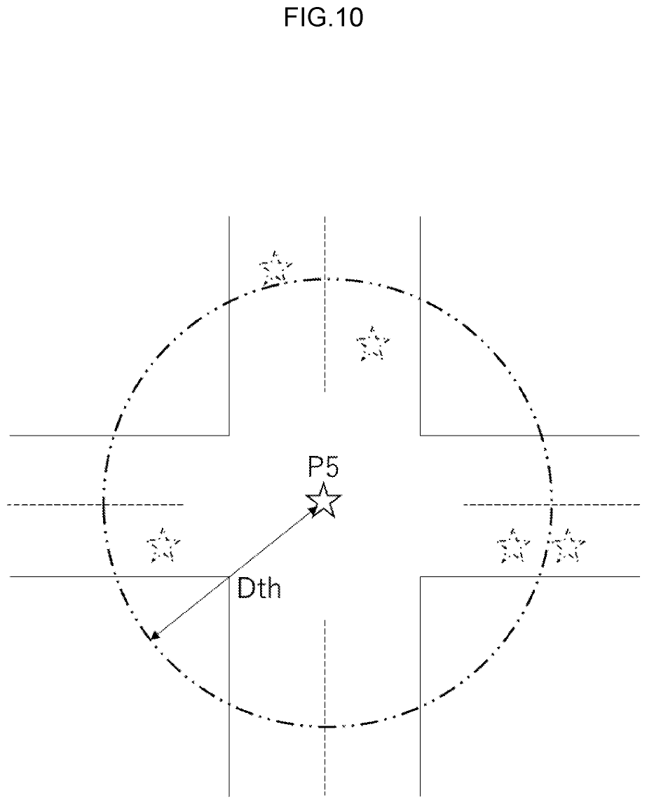

Moreover, in the present embodiment, in a case in which the number of times of the vehicles V carrying out sudden braking in the past on plural roads connecting to an intersection is a predetermined number or more, the danger spot updating section 96 registers the intersection as a danger spot in the server 12. This method is described with reference to FIG. 10.

FIG. 10 is a schematic drawing of a periphery of an intersection. As illustrated in FIG. 10, the number of times that the vehicles V carried out sudden braking in the past on the plural roads connected to the intersection is five times or more. In this case, the danger spot updating section 96 registers the intersection itself as a danger spot in the server 12.

In a case in which an intersection itself is registered in the server 12 as a danger spot, spot P5 that is at the center of the intersection is the danger spot. Therefore, the user is notified in a case in which the notification device 10 for a pedestrian enters into the range of the threshold value Dth from the danger spot P5. Note that the threshold value Dth in a case in which an intersection is registered as a danger spot may be set to a value that is greater than the threshold value Dth in a case in which a road connected to an intersection is registered as a danger spot.

(Operation)

Operation of the present embodiment is described next.

(Danger Spot Updating Processing)

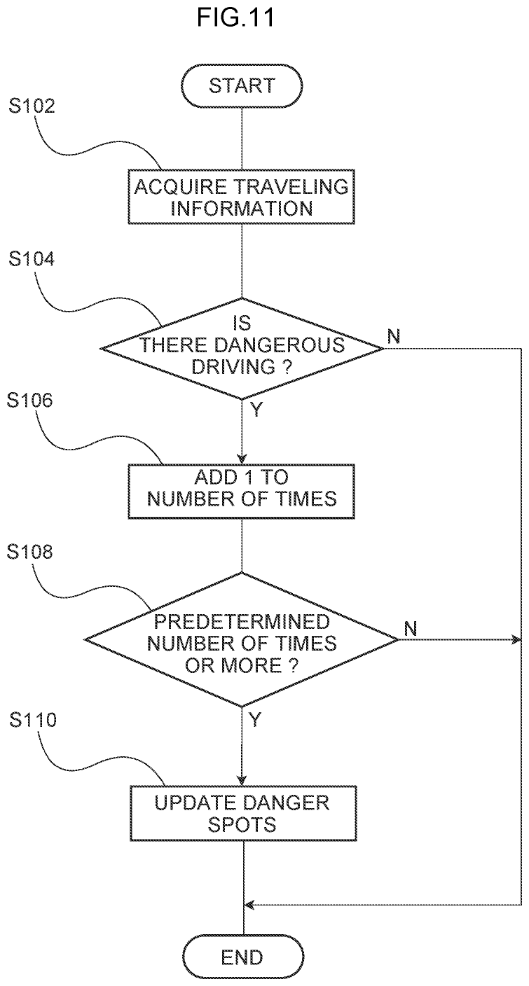

FIG. 11 is a flowchart illustrating an example of the flow of danger spot updating processing that is executed by the server 12. This danger spot updating processing is executed due to the CPU 40 reading-out a program from the ROM 42 or the storage 46 and expanding the program in the RAM 44.

In step S102, the CPU 40 acquires travel information. Concretely, by the function of the travel information acquisition section 90, the CPU 40 acquires travel information of the time of traveling from the vehicles V at which mutual communication with the server 12 via the network N is possible

In step S104, the CPU 40 judges whether or not there is dangerous driving. Specifically, by the function of the dangerous driving judging section 92, the CPU 40 analyzes the travel information, and thereby judges whether or not the vehicle V has carried out dangerous driving. For example, in a case in which, on the basis of the travel information, dangerous driving such as sudden braking, sudden steering, speeding, violation of a temporary stoppage regulation or the like has been carried out, the judgment in step S104 is affirmative, and the CPU 40 moves on to the processing of step S106.

On the other hand, in a case in which, on the basis of the travel information, the above-described dangerous driving has not been carried out, the judgement in step S104 is negative, and the CPU 40 ends the danger spot updating processing. Namely, in a case in which dangerous driving has not been carried out, the danger spot updating processing is ended without the updating of danger spots.

In step S106, the CPU 40 adds 1 to the number of times of dangerous driving. Specifically, by the function of the dangerous driving frequency counting section 94, the CPU 40 acquires, from the server 12 and for each spot, the number of times that it has been judged that there has been dangerous driving, and, for a spot at which there has been judged to be dangerous driving by the dangerous driving judging section 92, the CPU 40 adds one to the number of times of dangerous driving so as to update the number of times.

Next, in step S108, the CPU 40 judges, for each of the spots, whether or not the number of times of dangerous driving is a predetermined number of times or more. Specifically, by the function of the danger spot updating section 96, the CPU 40 registers a spot at which the number of times of dangerous driving is a predetermined number or more, in the server 12 as a danger spot, and thereby updates the information of the danger spots in step S110. Then, the CPU 40 ends the danger spot updating processing.

As described above, in the present embodiment, because the danger spot information that is stored in the server 12 is updated periodically, there is a state in which the latest danger spot information is always retained. Further, by registering, as danger spots, spots where dangerous driving has occurred regardless of the absence/presence of traffic accidents thereat, spots where dangerous driving occurs frequently can be effectively registered even if a traffic accident has not occurred thereat.

Moreover, in the present embodiment, the danger spots are updated on the basis of travel information acquired from the vehicles V. Therefore, danger spots can be updated on the basis of correct information, without the bother of information relating to dangerous driving being inputted by drivers or a manager or the like.

(Notification Processing)

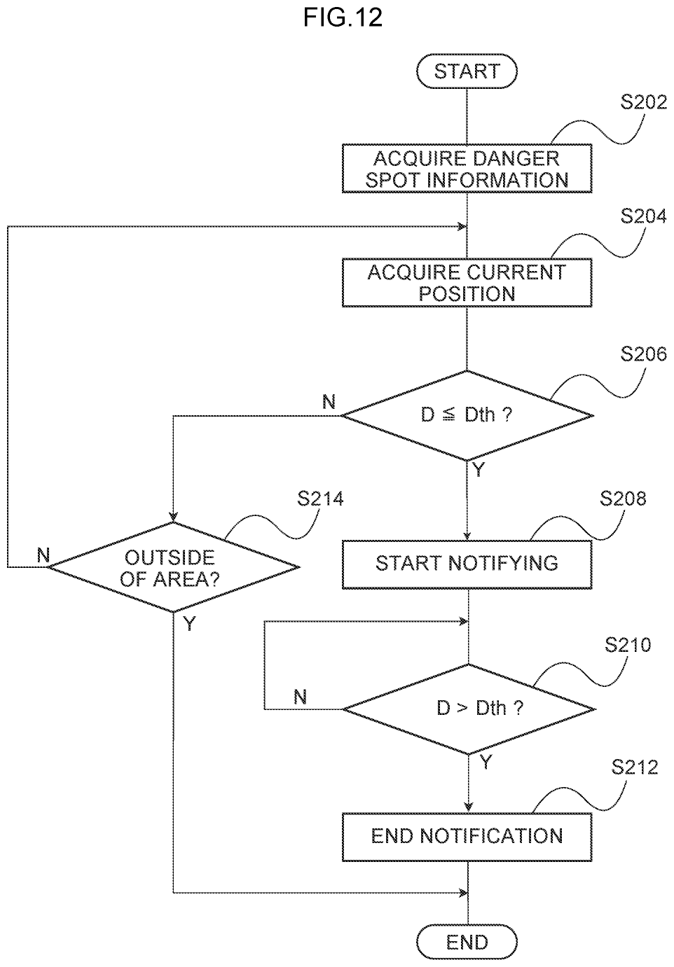

A flowchart illustrating an example of the flow of the notification processing executed by the notification device 10 for a pedestrian is described next with reference to FIG. 12. This notification processing is executed by the CPU 20 reading-out a program from the ROM 22 or the storage 26 and expanding the program in the RAM 24.

In step S202, the CPU 20 acquires danger spot information. Specifically, by the function of the danger spot information acquisition section 82, the CPU 20 acquires information relating to danger spots where dangerous driving has occurred in the past. Namely, the CPU 20 acquires, via the network N, danger spot information that is stored in the ROM 42 or the storage 46 of the server 12.

In step S204, the CPU 20 acquires the current position of the notification device 10 for a pedestrian. Specifically, by the function of the current position information acquisition section 80, the CPU 20 acquires position information that is measured by the GPS device 34.

In step S206, the CPU 20 judges whether or not the distance D between the current position and a danger spot is less than or equal to the predetermined threshold value Dth. If the distance D is less than or equal to the threshold value Dth, the judgment in step S206 is affirmative, and the CPU 20 moves on to the processing of step S208. On the other hand, if the distance D is greater than the threshold value Dth, the judgment in step S206 is negative, and the CPU 20 moves on to the processing of step S214. The processing of step S214 will be described first, and thereafter, processings from step S208 on will be described.

In step S214, the CPU 20 judges whether or not the notification device 10 for a pedestrian is positioned outside of an area. Specifically, in a case in which the position of the notification device 10 for a pedestrian that is measured by the GPS device 34 is outside of a preset notification area, the judgment in step S214 is affirmative, and the CPU 20 ends the notification processing. On the other hand, if the position of the notification device 10 for a pedestrian is within the notification area, the CPU 20 returns to the processing of step S204 and acquires the current position. In this way, in a case in which the notification device 10 for a pedestrian is positioned outside of the notification area, there is no need to notify the user, and therefore, the notification processing is ended.

If the judgment in step S206 is affirmative, the CPU 20 moves on to the processing of step S208, and starts the notifying. Specifically, by the function of the notification section 84, the CPU 20 notifies the pedestrian by at least one of the speaker 36 and the vibrator 38.

In step S210, the CPU 20 judges whether or not the distance D between the current position and the danger spot is greater than the predetermined threshold value Dth. If the distance D is greater than the threshold value Dth, the judgement in step S210 is affirmative, and the CPU 20 moves on to the processing of step S212. On the other hand, if the distance is less than or equal to the threshold value Dth, the judgment in step S210 is negative, and the CPU 20 repeats the processing of step S210. Namely, in the present embodiment, the processing of step S210 is repeated until the distance D becomes greater than the predetermined threshold value Dth. Note that a timing-out mechanism such as moving on to the processing of step S212 may be employed in a case in which a predetermined time elapses in the state in which the processing of step S210 is being repeated.

In step S212, the CPU 20 ends the notifying. Specifically, the CPU 20 ends the notifying that is carried out by the function of the notification section 84. Then, the CPU 20 ends the notification processing. Therefore, in the present embodiment, after the notifying is started in step S208, the notifying is continued during the time until the distance D becomes greater than the predetermined threshold value Dth. Note that the notification section 84 may notify the user intermittently. For example, in a case of notifying the user by outputting a voice message, the notification section 84 may output the voice message at a predetermined period.

As described above, in the notification device 10 for a pedestrian of the present embodiment, the current position of the notification device 10 for a pedestrian is acquired by the current position information acquisition section 80, and information relating to danger spots where dangerous driving has occurred in the past is acquired by the danger spot information acquisition section 82. Then, in a case in which the distance D between the current position and a danger spot becomes less than or equal to the predetermined threshold value Dth, the notification section 84 notifies the pedestrian who is the user. Due thereto, the user can understand that he/she is approaching a danger spot.

Further, because spots where dangerous driving has occurred in the past are set as the danger spots, the user can be notified at spots where dangerous driving and traffic violations occur often.

Moreover, in the present embodiment, the danger spot information acquisition section 82 does not acquire information relating to spots where dangerous driving, which is due to inattention of pedestrians, has arisen. Therefore, as compared with a structure in which notification is given at spots at which all types of dangerous driving have occurred, annoyance can be reduced while ensuring the safety of the user. Namely, if there is a large number of danger spots that are registered, the user is notified frequently, and there is the possibility that the user's vigilance and awareness will decrease. Therefore, by carrying out notification only at places that the user who is the pedestrian should pay attention to the most, the annoyance is reduced, and the vigilance and awareness of the user decreasing can be suppressed, while the safety of the user is ensured.

Still further, in the present embodiment, the user is notified only in cases in which the number of times that the vehicles V have suddenly braked in the past is a predetermined number of times or more. Therefore, the user is not notified in cases in which the number of times that the vehicles V have suddenly braked is less than the predetermined number of times. By not providing notice at spots where the number of times of sudden braking is low and the risk is low in this way, the annoyance can be reduced while the safety of the user is ensured.

In particular, in the present embodiment, spots where the vehicles V suddenly brake at the time of traveling straight are excluded from the danger spots. When the vehicle V carries out sudden braking while traveling straight, it is often the case that the intervehicle distance between the own vehicle and the preceding vehicle has become close, or the like. Therefore, by excluding such events that are not dangerous to pedestrians, the annoyance can be reduced while the safety of the user is ensured.

Further, in the present embodiment, as illustrated in FIG. 10, in a case in which number of times of the vehicles V suddenly braking in the past on plural roads connected to an intersection is a predetermined number or more, the danger spot information acquisition section 82 acquires the intersection as a danger spot. Due thereto, the number of danger spots can be reduced as compared with a case in which the respective roads are made to be danger spots. Further, management as a dangerous intersection is possible.

Moreover, in the present embodiment, notification is not given in cases in which the number of times that temporary stoppage violations of the vehicles V occurred in the past is less than a predetermined number of times. Similarly, notification is not given in cases in which the number of times that speeding of the vehicles V occurred is less than a predetermined number of times, and in cases in which the number of times that sudden steering occurred is less than a predetermined number of times. Due thereto, the annoyance can be reduced while the safety of the user is ensured.

Although the notification device 10 for a pedestrian relating to an embodiment has been described above, the technique of the present disclosure can, of course, be implemented in various forms within a scope that does not depart from the gist thereof. For example, the above-described embodiment is structured such that the notification section 84 notifies the pedestrian by at least one of the speaker 36 and the vibrator 38. However, the present disclosure is not limited to this, and a device that uses bone conduction may be used. In this case, notification is given without the need to output sound at the periphery of the pedestrian.

The above-described embodiment is structured such that the dangerous driving judging section 92 judges whether or not sudden braking, sudden steering, speeding or a temporary stoppage violation has occurred, as dangerous driving. However, the present disclosure is not limited to this, and, for example, the dangerous driving judging section 92 may judge whether or not there is sudden acceleration or vehicle lane departure or the like as dangerous driving, in addition to the above events.

Moreover, although the above-described embodiment is structured such that the notification system S for a pedestrian includes the notification device 10 for a pedestrian and the server 12, the present disclosure is not limited to this. For example, the notification system S for a pedestrian may be structured to include a portable terminal that can communicate with the notification device 10 for a pedestrian. The portable terminal may be terminal that is carried by the guardian of the child to which the notification device 10 for a pedestrian is attached, or the like. In this case, a structure may be employed in which, in a case in which the distance between the current position and a danger spot becomes a predetermined threshold value or less, the notification section 84 of the notification device 10 for a pedestrian notifies the child, and also transmits a predetermined message to the portable terminal carried by the guardian.

Still further, the shape of the notification device 10 for a pedestrian, and the subject to which the notification device 10 for a pedestrian is attached, and the like are not particularly limited. For example, the notification device 10 for a pedestrian may be a shape such that it can be mounted to a cane or the like carried by a user with leg trouble such as an elderly person or the like. Or, the notification device 10 for a pedestrian may be in the form of eyeglasses or the like.

Further, the notification device 10 for a pedestrian may be a structure in which a sensor, such as an optical camera or the like, is installed. In this case, the current position of the pedestrian, and obstacles such as vehicles and the like, may be recognized on the basis of image information captured by the optical camera.

Moreover, any of various types of processors other than the CPU 20 and the CPU 40 may execute the processings that are executed due to the CPU 20 and the CPU 40 reading-in programs in the above-described embodiment. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the above-described processings may be executed by one of these various types of processors, or may be executed by a combination of two or more of the same type or different types of processors, e.g., plural FPGAs, or a combination of a CPU and an FPGA, or the like. Further, the hardware structures of these various types of processors are, more specifically, electrical circuits that combine circuit elements such as semiconductor elements and the like.

Further, the above embodiment is a structure in which various data are stored in the storage 26 and the storage 46, but the present disclosure is not limited to this. For example, a non-transitory recording medium such as a CD (Compact Disk), a DVD (Digital Versatile Disk), a USB (Universal Serial Bus) memory or the like may be used as the storage. In this case, the various programs and data and the like are stored in these recording media.

The flows of the processings described in the above embodiment are examples, and unnecessary steps may be deleted therefrom, new steps may be added thereto, or the order of processings may be rearranged, within a scope that does not depart from the gist of the present disclosure.

What is claimed is:

1. A notification device for a pedestrian, comprising a processor, the processor being configured to:
acquire current position information;
acquire information relating to danger spots at which dangerous driving has occurred in the past; and
provide notification in a case in which a distance between a current position and a danger spot has become less than or equal to a predetermined threshold value.

2. The notification device for a pedestrian of claim 1, wherein the processor acquires information relating to danger spots at which dangerous driving due to inattention by drivers of vehicles has occurred in the past, and does not acquire information relating to danger spots at which dangerous driving due to inattention by pedestrians has occurred.

3. The notification device for a pedestrian of claim 1, wherein the processor acquires information including spots at which a number of times that vehicles have carried out sudden braking in the past is a predetermined number or more, as the danger spots.

4. The notification device for a pedestrian of claim 3, wherein the processor acquires information including spots at which a number of times that vehicles have carried out sudden braking immediately after a left or right turn in the past is a predetermined number or more, as the danger spots.

5. The notification device for a pedestrian of claim 3, wherein, in a case in which a number of times that vehicles have carried out sudden braking in the past on a plurality of roads connected to an intersection is a predetermined number or more, the processor acquires the intersection as a danger spot.

6. The notification device for a pedestrian of claim 1, wherein the processor acquires information including spots at which a number of times that temporary stoppage violations of vehicles have occurred in the past is a predetermined number or more, as the danger spots.

7. The notification device for a pedestrian of claim 1, wherein the processor acquires information including spots at which a number of times that speeding of vehicles has occurred in the past is a predetermined number or more, as the danger spots.

8. The notification device for a pedestrian of claim 1, wherein the processor acquires information including spots at which a number of times that sudden steering of vehicles has occurred in the past is a predetermined number or more, as the danger spots.

9. A notification system for a pedestrian, comprising:
the notification device for a pedestrian of claim 1; and
a server in which information relating to the danger spots is stored,
wherein the server acquires travel information regarding times of travel from vehicles, and
the notification system updates information relating to danger spots on the basis of the acquired travel information.

10. A notification method for a pedestrian, comprising, by a processor:
acquiring current position information;
acquiring information relating to danger spots at which dangerous driving has occurred in the past; and
providing notification in a case in which a distance between a current position and a danger spot has become less than or equal to a predetermined threshold value.

11. A non-transitory storage medium storing a program executable by a computer to perform processing, the processing comprising:
acquiring current position information;
acquiring information relating to danger spots at which dangerous driving has occurred in the past; and
providing notification in a case in which a distance between a current position and a danger spot has become less than or equal to a predetermined threshold value.
